(19) United States
(12) Patent Application Publication
(10) Pub. No.: US 2009/0008480 A1
(43) Pub. Date: Jan. 8, 2009

(54) Dual spray injection nozzle

(76) Inventor: Michael Peter Cooke, Gillingham (GB)

Correspondence Address: DELPHI TECHNOLOGIES, INC., M/C 480-410-202, PO BOX 5052, TROY, MI, 48007, US

(21) Appl. No.: 12/217,350

(22) Filed: Jul. 3, 2008

(30) Foreign Application Priority Data
Jul. 6, 2007 (EP) 07252731.0

(51) Int. Cl. F02M 61/00

(52) U.S. Cl. 239/533.12

(57) ABSTRACT

A fuel injector for an internal combustion engine comprising a nozzle body defining a nozzle bore and an outer valve needle that is slideably positioned within the nozzle bore. The outer valve needle is engageable fluidtightly with a valve seat provided on an internal surface of the nozzle bore, in order to control fuel delivery through at least one upper spray hole that is positioned so as to provide a flow path through the wall of the nozzle body. The upper spray hole has a hole entry positioned on an internal surface of the nozzle body and a hole exit positioned on an external surface of the nozzle body. The outer valve needle is provided with a bore, within which an inner valve needle is slideably positioned. The tip of the inner valve needle is engageable fluidtightly with a valve seat in order to control fuel delivery through at least one axial spray hole (19) that is aligned substantially parallel to the longitudinal axis of the injector nozzle.

The present invention relates to a nozzle arrangement for a fuel injector for an internal combustion engine. In particular, the present invention relates to a nozzle arrangement that comprises two valves that can be independently opened and closed in order to deliver fuel into the cylinder of the internal combustion engine through a plurality of axially offset spray holes and through an axially directed spray hole.

In order to meet the requirements set by future legislation on emissions it is proposed to use Homogeneous Charge Compression Ignition (HCCI) engines. However, operation in an HCCI combustion mode is only suitable for light to moderate engine loads. For high engine loads a conventional combustion mode must be used. The requirements for the injection sprays in HCCI and conventional combustion modes are different. For conventional combustion it is desired to have highly penetrating sprays injecting towards the walls of the cylinder through the dense gas in the piston bowl, as quickly as possible. For HCCI combustion it is desired to have a low penetration spray pointing downwards with good atomisation. Therefore, if both modes of combustion are to be used in a single engine there is a need for a fuel injector nozzle that is able to provide both types of spray.

Accordingly, the present invention provides a fuel injector for an internal combustion engine comprising, a nozzle body defining a nozzle bore, and an outer valve needle slideably positioned within the nozzle bore, wherein the outer valve needle is engageable fluidtightly with a valve seat provided on an internal surface of the nozzle bore, in order to control fuel delivery through at least one upper spray hole positioned so as to provide a flow path through the wall of the nozzle body and that has a hole entry positioned on an internal surface of the nozzle body and a hole exit positioned on an external surface of the nozzle body, wherein the outer valve needle (25) is provided with a bore, within which an inner valve needle is slideably positioned and wherein the tip of the inner valve needle is engageable fluidtightly with a valve seat in order to control fuel delivery through at least one axial spray hole that is aligned substantially parallel to the longitudinal axis of the injector nozzle, characterised in that, in use, when the inner valve needle is lifted away from the valve seat and held in an uppermost raised position, the minimum flow area, through which fuel to be injected through the axial spray hole must pass, is positioned between the inner valve needle and the nozzle body.

Preferably, in use, when the outer valve needle is lifted away from its valve seat and held in an uppermost raised position, the minimum flow area of the at least one upper spray hole causes the greatest restriction of the flow rate of fuel through the at least one upper spray hole and when the inner valve needle is lifted away from its valve seat and held in an uppermost raised position, the minimum flow area between the tip of the inner valve needle and the valve seat causes the greatest restriction of the flow rate of fuel through the at least one axial spray hole. As a result, and in contrast to the arrangement of a conventional nozzle spray hole that is configured to provide the highest spray velocity, the greatest restriction is not formed by the final orifice in the fuel flow path through the injector. This reduces the velocity and momentum of the fuel but increases its atomisation.

Preferably, the valve seat is frustoconical and the tip is conical wherein when, in use, the tip is raised away from the valve seat the minimum flow area between the tip and its valve seat is formed as a conical annular region. This arrangement is advantageous because the fuel passing through the conical annular region is funnelled to a point within the axial spray hole such that it collides with itself. This results in a reduction in the momentum of the fuel and an increase in its atomisation. Furthermore, the arrangement of the injector produces a hollow conical spray form from the axial spray hole. This is advantageous because the penetration of the injected fuel into the combustion chamber is decreased relative to an axial fuel injection, thereby preventing the fuel from impinging on the piston, and because it aids dissipation of the injected fuel within the combustion chamber due to the wider area, across which the fuel is spread. Alternatively, the tip may have any suitable form, for example it may have a part-spherical shape.

Preferably, the inner valve needle is provided with at least one groove parallel to its external surface and arranged diagonally relative to the longitudinal axis of the inner valve needle. The diagonal arrangement of the grooves also increases the atomisation of the fuel as it introduces a further rotational, or swirl, component into the spray in addition to that already provided by the offset radial drillings.

In a first preferred embodiment of the present invention, the outer valve needle is provided with a first radial drilling and a second radial drilling that pass through the wall of the outer valve needle from an external surface to an internal surface of the bore, wherein the first radial drilling is offset to one side of the longitudinal axis of the outer valve needle and the second radial drilling is offset to the other side of the longitudinal axis of the outer valve needle. The offsetting of the radial drillings imparts a rotational component of velocity to the fuel. This is advantageous for improved atomisation of the fuel delivered through the spray holes.

Although it is desirable to introduce a component of swirl into the fuel in order to enhance atomisation it is desirable to reduce the rotational forces, to which the inner valve needle is subjected when it has been lifted from the valve seat. If the rotation were to be imparted to the fuel solely through the diagonal grooves the forces on the inner valve needle would be high. By introducing a component of rotation via the offset radial drillings the rotational forces, to which the inner valve needle is subjected are reduced. In addition the offset radial drillings reduce the pressure drop required to generate a given amount of rotation. This results from a reduction in the angle, through which the flow direction of the fuel must change when the fuel passes from the radial drillings to the diagonal grooves. This reduces the turbulence and hence the pressure drop.

In a second preferred embodiment of the present invention the outer valve needle is provided with a first radial drilling and a second radial drilling that pass through the wall of the outer valve needle from an external surface to an internal surface of the bore, wherein the longitudinal axes of the first and second radial drillings are aligned and intersect the longitudinal axis of the outer valve needle.

The first preferred embodiment of the present invention utilises features of the described arrangement to produce swirl in the fuel to enhance atomisation. However, for some applications of a fuel injection nozzle 1 according to the present invention it may be more desirable to retain the momentum of the fuel. For example, it is desired to maintain fuel momentum for efficient conventional combustion.

Preferably, in use, when the inner valve needle is seated against the valve seat the lowest point of the tip is positioned within the axial spray hole.

Preferably, in use, the inner valve needle is raised away from the valve seat to its uppermost position the lowest point of the tip is positioned within the axial spray hole.

In a third embodiment of the present invention, the fuel injector further comprises an insert, wherein a lower part of the insert is sealingly engaged with an internal surface of the bore of the nozzle body, an upper part of the insert is sealingly engageable with the tip of the inner valve needle and an outer part of the insert is sealingly engageable with the bore of the outer valve needle.

The inclusion of an insert prevents fuel that passes through the upper spray holes being imparted with a rotational component of velocity.

Alternatively, the tip may further comprise a cylindrical lower section. Restriction of the axial flow between the cylindrical section and the axial spray hole may result in the spray having a narrower cone angle and hence greater axial penetration.

Preferably, the lower section is provided with a flat section. In operation, the provision of the flat section creates a spray having a desirable profile. In addition, the flat section helps to clear soot and lacquer deposits from the axial spray hole. As the inner valve needle rotates the relatively sharp edges of the flat section come into contact with the deposits and dislodge them.

Preferably, the tip is provided with a frustoconical upper section, an intermediate section that is circular in cross-section and that has a concave curved profile and a cylindrical lower section.

The spray profiles issuing from the axial spray holes in the described embodiments are used for HCCI combustion. It is desired that the shape of the tip of the inner valve needle can be modified so that the spray profile can be matched to the engine, to which the injector is fitted. For example, it is desirable to match the cone angle of the spray profile to the piston and cylinder geometry

In operation the provision of a curved section on the needle tip imparts a greater radial component to the spray. As discussed above, this is advantageous for example for matching the spray profile to the combustion chamber characteristics.

Preferred embodiments of the present invention will now be described with reference to the accompanying drawings, in which:

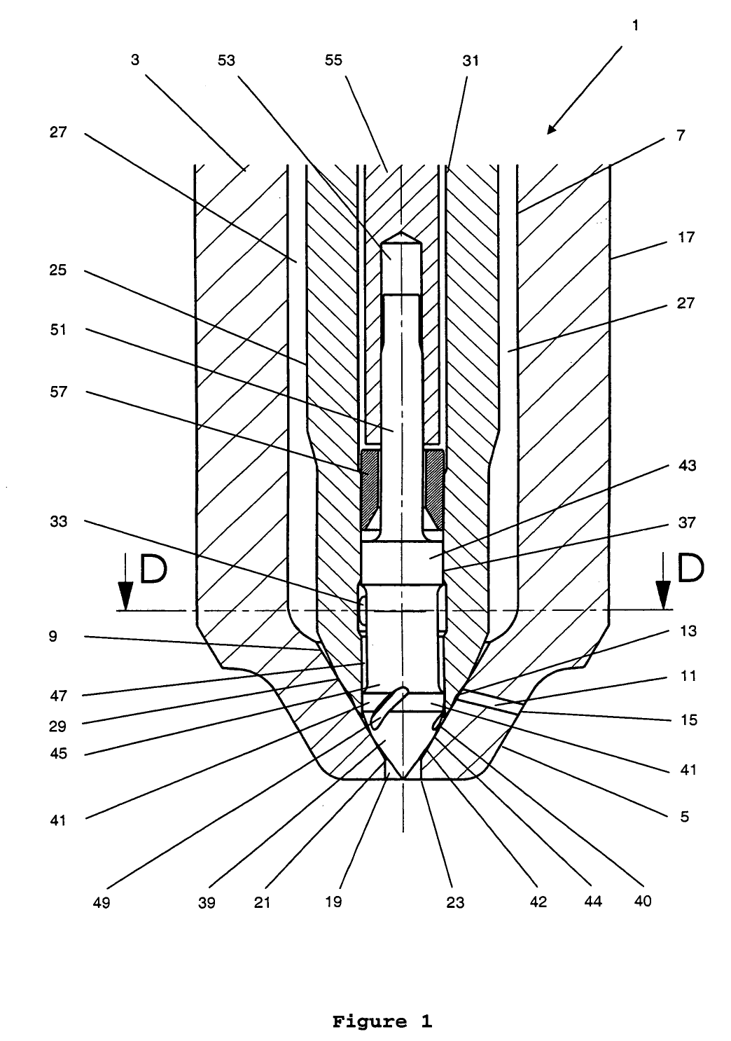

FIG. 1 is a cross-sectional elevation of a part of a fuel injection nozzle according to a first embodiment of the present invention;

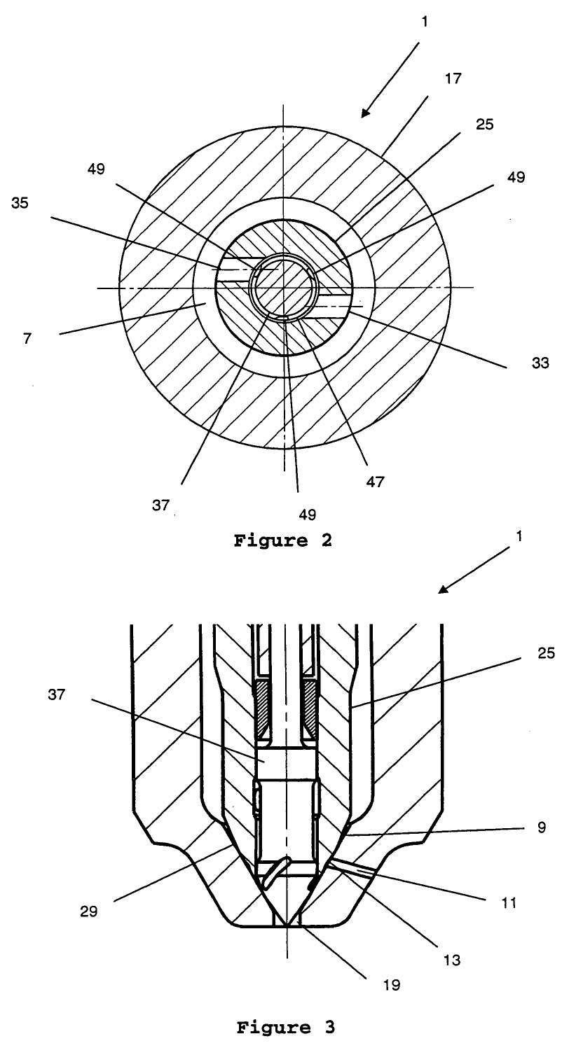

FIG. 2 is a cross-sectional plan view of the fuel injection nozzle of FIG. 1, taken at line D-D of FIG. 1;

FIG. 3 is a cross-sectional elevation of a part of the fuel injection nozzle of FIG. 1, in which both the inner valve the outer valve are closed;

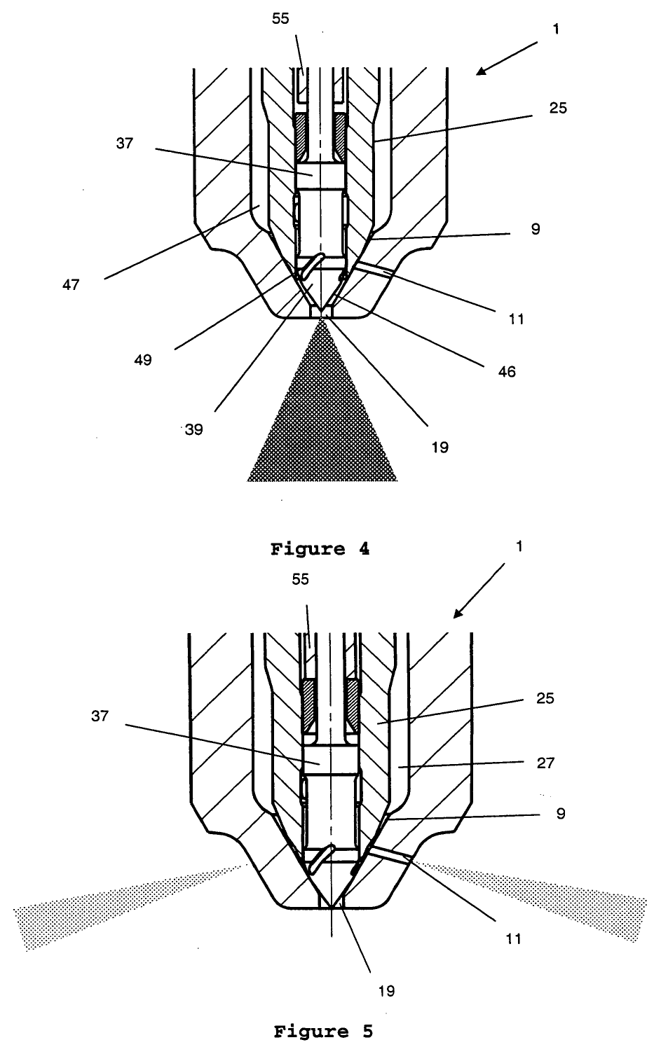

FIG. 4 is a cross-sectional elevation of a part of the fuel injection nozzle of FIG. 1, in which the inner valve is open and the outer valve is closed;

FIG. 5 is a cross-sectional elevation of a part of the fuel injection nozzle of FIG. 1, in which the inner valve is closed and the outer valve is open; and

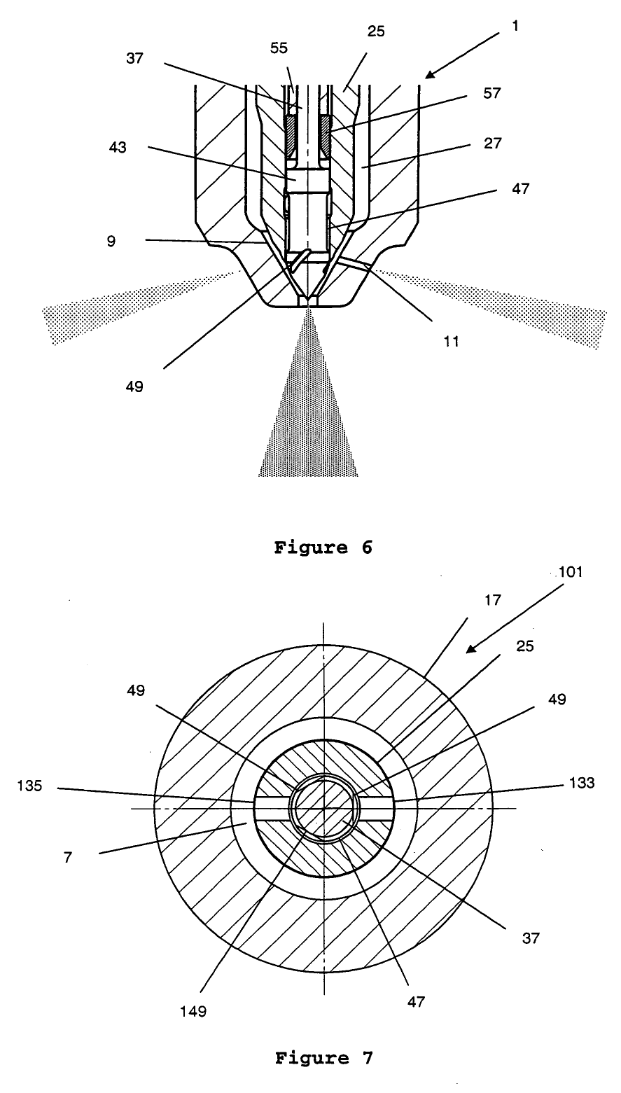

FIG. 6 is a cross-sectional elevation of a part of the fuel injection nozzle of FIG. 1, in which both the inner valve the outer valve are open.

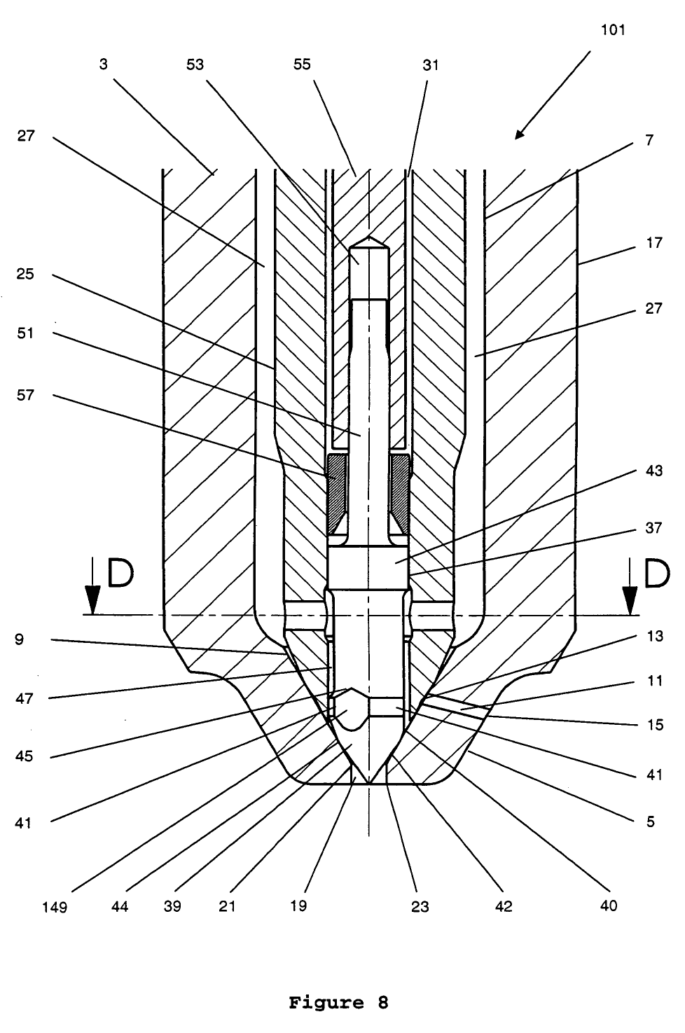

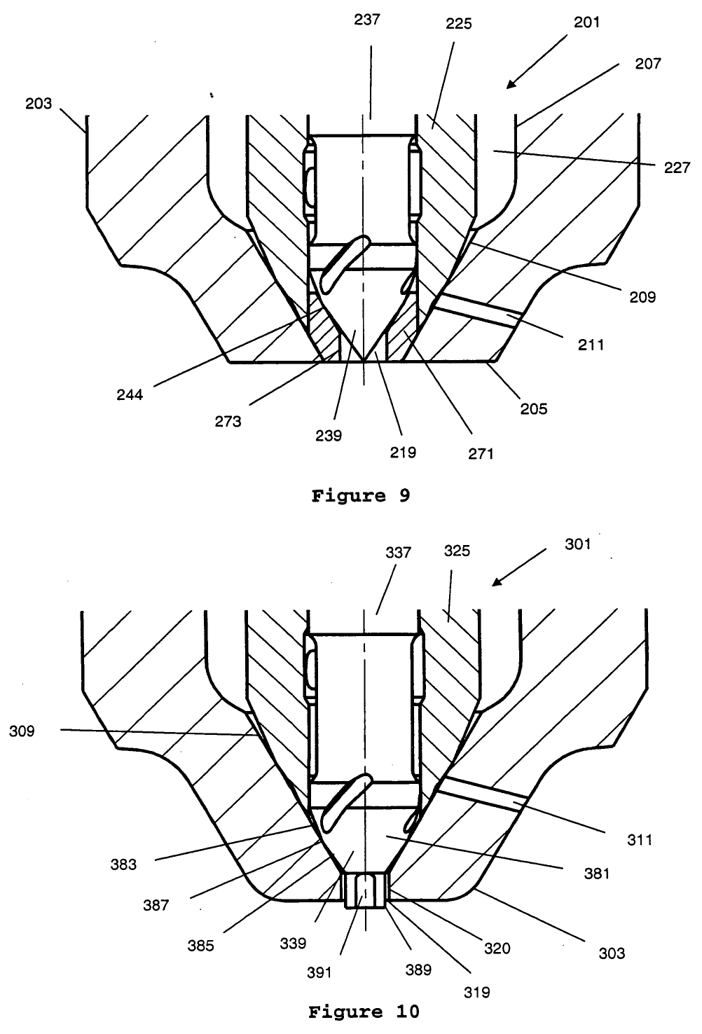

FIG. 7 is a cross-sectional plan view of a fuel injection nozzle according to a second embodiment of the present invention, taken at line D-D of FIG. 8;

FIG. 8 is a cross-sectional elevation of a part of the fuel injection nozzle of FIG. 7;

FIG. 9 is a cross-sectional elevation of a part of a fuel injection nozzle according to a third embodiment of the present invention;

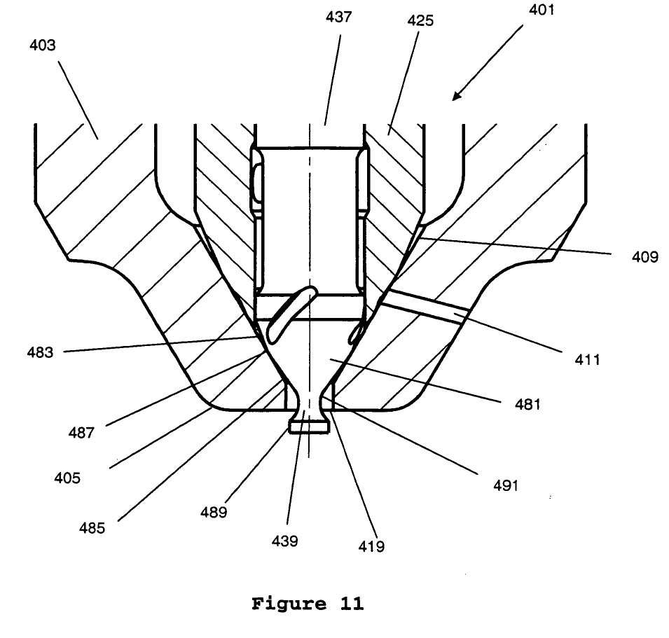

FIG. 10 is a cross-sectional elevation of a part of an alternative inner valve needle that can be utilised in any one of the first, second or third embodiments of the present invention; and

FIG. 11 is a cross-sectional elevation of a part of a further alternative inner valve needle that can be utilised in any one of the first, second or third embodiments of the present invention.

FIG. 1 illustrates a first embodiment of a fuel injection nozzle 1 according to the present invention. The fuel injection nozzle 1 comprises an outer, generally cylindrical and hollow, nozzle body 3 that tapers at one end to a frustoconically shaped tip 5. Within the nozzle body 3 there is a nozzle bore 7 that is generally cylindrical along most of the length of the nozzle body 3 and that has a frustoconical section inside the tip 5. This frustoconical section forms a valve seat 9. In this description the downward direction is the direction along the injection nozzle 1 towards the tip 5. Thus the lower end of a component is the end positioned downwardly and the upper end of a component is the end positioned uppermost.

The tip 5 is provided with a row of radially equally spaced upper spray holes 11 that pass through the wall of the nozzle body 3. The spray holes 11 each have a hole entry 13 positioned on the valve seat 9 and a hole exit 15 positioned on the external wall 17 of the nozzle body 3. The axis of each spray hole 11 is positioned at a downwardly directed obtuse angle in relation to the longitudinal axis of the nozzle body 3 so that the fuel passing through the spray holes 11 has a large radial component of velocity.

The tip 5 is also provided with a single axial spray hole 19 that passes through the wall of the nozzle body 3. The spray hole 19 is aligned coaxially with the axis of the nozzle body 3 and has a hole entry 21 positioned on the valve seat 9 and a hole exit 23 positioned on the external wall 17 of the nozzle body 3.

The injection nozzle 1 also comprises a generally cylindrical outer valve needle 25. The outer valve needle 25 is slideably positioned within the nozzle bore 7 and is aligned coaxially with it. The external diameter of the outer valve needle 25 is less than the diameter of the nozzle bore 7 such that an annular space referred to as a fuel delivery chamber 27 is formed between them. The outer valve needle 25 is provided at its lower end with a conical section 29 that has a profile that is complementary to the valve seat 9, such that if the outer valve needle 25 is positioned against the valve seat 9 a seal is created between them. The outer valve needle 25 has a generally cylindrical bore 31 that is open at its lower end. Two radial drillings 33,35, drilling 33 is partially shown in FIG. 1 and drillings 33,35 are shown in FIG. 2, pass through the wall of the outer valve needle 25. As can be seen from FIG. 2 one of the drillings 33 is offset to one side of the longitudinal axis of the outer valve needle 25 and the other drilling 35 is offset to the other side.

Slideably positioned within the outer valve needle 25 is an inner valve needle 37 having a circular cross-sectional profile. The valve needle 37 is provided at its lower end with a conical tip 39. The tip 39 has two sections. An upper frustoconical section 40 that has a relatively narrow included cone angle and a lower conical section 42 that has a relatively wide included cone angle. Where the two sections 40,42 meet a ridge 44 is formed. When the tip 39 is positioned against the valve seat 9 a seal is formed between the ridge 44 and the valve seat 9. Further up the inner valve needle 37, above the tip 39, is a lower guide section 41 and an upper guide section 43. The guide sections 41,43 have an external diameter that closely matches the diameter of the bore 31, such that the inner valve needle 37 is guided when it slides within the outer valve needle 25 but the passage of fuel across the guide sections 41,43 is minimised. The guide sections 41,43 are axially spaced apart and between them is provided an intermediate section 45 of smaller external diameter. This creates an annular space referred to as a fuel delivery chamber 47 between the bore 31 of the outer valve needle 25 and the inner valve needle 37. The guide sections 41,43 are spaced apart on the valve needle 37 such that when the needle 37 is fitted inside the bore 31 the radial drillings 33,35 are in communication with the fuel delivery chamber 47 for all operational positions of the needle 37.

Between the fuel delivery chamber 47 and the tip 39, across lower guide section 41, there are provided three grooves 49 that permit fuel to flow across the otherwisely tightly fitting guide section 41. The grooves 49 are equally spaced around inner valve needle 37 and are arranged diagonally relative to the longitudinal axis of the valve needle 37.

Above the upper guide portion 43 and extending to the upper end of the inner valve needle 37 there is provided an elongate stem 51 of smaller cross-section than the intermediate section 45. The stem 51 is an interference fit with a blind bore 53 provided in a carrier 55. The carrier 55 is linked to an actuator (not shown) that raises and lowers the inner valve needle 37.

In the assembled injection nozzle 1, in between the upper guide portion 43 and the carrier 55 there is positioned a ring-shaped coupler 57. The internal diameter of the coupler 57 is larger than that of the stem 51, so that the stem 51 may slide through it. The external diameter of the coupler 57 is chosen so that it is an interference fit with the bore 31 of the outer valve needle 25 such that in operation the coupler 57 does not move relative to the outer valve needle 25.

In use, high pressure fuel fills the fuel delivery chamber 27 through an inlet (not shown). The fuel flows through radial drillings 33,35 into fuel delivery chamber 47 and fills the grooves 49.

FIG. 3 shows the fuel injection nozzle 1 in a closed position, i.e. with the outer valve needle 25 and the inner valve needle 37 both positioned against valve seat 9. The conical section 29 of the outer valve needle 25, when positioned against the valve seat 9 covers the hole entry 13 to the spray hole 11. Thus, in this position no fuel flow can pass across the valve seat 9 and there is no flow through the upper spray holes 11 or the axial spray hole 19.

FIG. 4 shows the fuel injection nozzle 1 in a first open position. The outer valve needle 25 is positioned against the valve seat 9 and thus there is no fuel flow through spray holes 11. The carrier member 55 has been moved partially upwards and the inner valve needle 37 has been lifted from valve seat 9. Fuel flows into the delivery chamber 47 from delivery chamber 27 via radial drillings 33,35. As the fuel flows through the radial drillings 33,35 a rotational component of velocity is imparted to the fuel as a result of the radial drillings being offset from the longitudinal axis of the outer valve needle. Fuel from the delivery chamber 47 can then flow through grooves 49 across valve seat 9 and through axial spray hole 19. This position is utilised when the injector is being used in an HCCI combustion mode.

The lifting of the inner valve needle 37 from the valve seat 9 results in the creation of a conical annular flow region 46 around the tip 39. This annular flow region 46 acts as a restriction to the flow of fuel through axial spray hole 19. Fuel passing through this annular region 46 is directly inwardly towards the longitudinal axis of the nozzle 1 as it is funnelled to the axial spray hole 19. Consequently, the fuel passing through the annular region 46 collides with itself as it exits the nozzle 1 through spray hole 19.

The diameter of the axial spray hole 19 results in a flow area through the spray hole 19 that is larger than the flow area through the conical annular flow region 46 and thus does not act as a restriction to the flow of fuel through it.

FIG. 5 shows the fuel injection nozzle in a second open position. The carrier member 55 is in a downwards position and thus the inner valve needle 37 is held against the valve seat 9 such that no fuel can flow from chamber 47 through axial spray hole 19. The outer valve needle 25 is lifted from the valve seat 9 such that fuel can flow through spray holes 11. This position is utilised when the injector is being used in a conventional combustion mode. In this arrangement a component of the fuel passing out of the spray holes 11 comes directly from the fuel delivery chamber 27, across the valve seat 9, and a component comes from the fuel delivery chamber 27, via the fuel delivery chamber 47 and then across the valve seat 9. As a result the fuel passing through the spray holes 11 has been imparted with a rotational component of velocity by virtue of the offset radial drillings 33,35 feeding the fuel delivery chamber 47.

The diameter of the hole entry 13, the hole exit 15 and the bore of the spray hole 11 act as a restriction to the flow of fuel from the chambers 27,47 through the spray holes 11. The diameters are chosen to give a desired flow rate at a given pressure.

FIG. 6 shows the fuel injection nozzle in a third open position. The outer needle 25 has been fully lifted away from the valve seat 9. In doing so, the coupler 57 has been brought into contact with the carrier member 55 such that the inner valve needle 37 has been lifted from valve seat 9. Fuel can flow through spray holes 11 and from delivery chamber 47 through axial spray hole 19. The characteristics of the fuel sprays leaving the spray holes 11 and the axial spray hole 19 is the same as that from the spray holes 11,19 if they are opened separately, as described above.

FIGS. 7 and 8 illustrate a second embodiment of a fuel injection nozzle 101 according to the present invention, in which the nozzle components are arranged to preserve the momentum of the fuel being injected.

The radial drillings 133,135, shown in FIG. 7, are axially aligned to each other and their mutual axis passes through the centreline of the outer valve needle 25. Between the fuel delivery chamber 47 and the tip 39, across lower guide section 41 there are provided three flat sections 149 that permit fuel to flow across the otherwisely tightly fitting guide section 41. The flat sections 149 are arranged parallel to the longitudinal axis of the inner valve needle 37 and are straight sided, with the sides also aligned parallel to the longitudinal axis.

In use, the fuel, which passes through the radial drillings 133,135 and flat sections 149, does not have a rotational component imparted to it and hence there is no consequential loss of momentum.

In another application of a fuel injection nozzle 1 according to the present invention it may be desirable to introduce a component of swirl into the fuel passing through the axial spray hole 19 but not into the fuel passing through upper spray holes 11.

FIG. 9 illustrates a third embodiment of a fuel injection nozzle 201 of the present invention, in which the nozzle components are arranged to achieve this desirable operation.

An insert 271 is placed in the bore 207 in the nozzle body 203 adjacent to tip 205. The insert 271 has an annular cross-sectional profile and is coaxially aligned with the outer valve needle 225 and the inner valve needle 237. The insert 271 is aligned such that its bottom end is flush with the external surface of the nozzle body 203. The external cylindrical surface of the insert 271 is provided towards the bottom with a tapered surface complementary with that of the valve seat 209 so that it seals with the valve seat 209. The internal cylindrical surface of the insert 271 is provided towards the top with a tapered surface so that a seal with the ridge 244 on the inner valve needle 237 can be created. The external diameter of the insert 271 is complementary to the internal diameter of the outer valve needle 225 so that a seal can be created between the insert 271 and the outer valve needle 225, whilst still permitting the valve needle 225 to move relative to it. The height of the insert 271 is chosen such that when the outer valve needle 225 is fully lifted away from the valve seat 209 there is still an overlap between the insert 271 and the valve needle 225. This ensures that fuel flowing into the inside of the outer valve needle 225 cannot pass through the upper spray holes 211 when the valve needle 225 is lifted. To accommodate the insert 271 the opening at the tip 205 of the nozzle body 203 is enlarged. The insert 271 is provided with a bore 273 that creates an axial spray hole 219. In the same manner as the first and second embodiments of the present invention the axial spray hole 219 does not provide the greatest restriction to the flow of fuel from the injection nozzle 201. The greatest flow restriction results from fuel flowing through the conical annular flow region 246 between the insert 271 and the tip 239 of the inner valve needle 237.

In operation, with both the outer valve needle 225 and the inner valve needle 237 raised from the valve seat 209, the fuel passing through the spray holes 211 comes only directly from the fuel delivery chamber 227 via the valve seat 209 and hence there is no rotation imparted to it.

In some applications it may also be desired to change the shape of the spray from the axial spray hole. FIGS. 10 and 11 show two nozzle arrangements, in which the shape of the tip of the inner valve needle 337,437 has been changed to provide different spray profiles.

FIG. 10 illustrates an inner valve needle 337 provided with a pintle tip 339. The tip 339 has three sections. An upper section 381 is frustoconical and has an external profile that is created by a first section 383 with a relatively narrow included cone angle and a second section 385 with a relatively wide included cone angle wherein a ridge 387 is created at the intersection of the sections 383,385. At the bottom of the tip 339 is a cylindrical lower section 389. The section 389 has an external diameter that is smaller than the diameter of the spray hole 319 such that an annular space 320 is created between the section 389 and the spray hole 319. This annular space 320 acts as the restriction to the flow of fuel through the axial spray hole 319, rather than the conical annular flow region 346 between the valve seat 309 and the tip 339.

When the inner valve needle 337 is in the lowermost position, the ridge 387 seals with the valve seat 309. In this position the section 389 protrudes through the axial spray hole 319 and extends past the external surface of the tip 305 of the nozzle body 30, so that when the inner valve needle 337 lifts the end of the section 389 is flush with the end of the nozzle body 303. This creates a desirable spray pattern.

The section 389 is provided with a straight sided flat section 391 that is arranged parallel to the longitudinal axis of the inner valve needle 337 with the straight sides also parallel to the axis.

FIG. 11 illustrates an inner valve needle 437 having a further form of pintle tip 439. The tip 439 has three sections. An upper section 481 is frustoconical and has an external profile that is created by a first section 483 with a relatively narrow included cone angle and a second section 485 with a relatively wide included cone angle wherein a ridge 487 is created at the intersection of the sections 483,485. At the bottom of the tip 439 is a cylindrical lower section 489. The diameter of section 489 is less than the diameter of the axial spray hole 419. Between the sections 483,485 there is a circular cross-section intermediate section 491 that has a concave curved profile that joins the upper outer edge of the section 489 to the lower edge of section 485.

When the inner valve needle 437 is in the lowermost position the ridge 487 seals with the valve seat 409. In this position the whole of section 489 and part of section 491 are positioned below the external surface of the tip 405. When the inner valve needle is in the uppermost position, i.e. when both the inner valve needle 437 and the outer valve needle 425 are raised, the section 489 is positioned within the spray hole 419 such that a cylindrical annular flow area 486 is created between the section 489 and the spray hole 419. In a partially raised position the section 489 remains outside of the nozzle body 403.

When the inner valve needle 437 is fully raised and the section 489 is positioned within the spray hole 419 the greatest flow restriction for fuel leaving the injection nozzle 401 results from fuel flowing through the annular flow region 486 around the tip 439. In any other position of the inner valve needle 437 the greatest flow restriction is the conical annular flow region 446 between the valve seat 409 and the tip 439.

1. A fuel injector for an internal combustion engine comprising:
a nozzle body having a wall with an internal surface and an external surface, the internal surface defining a nozzle bore and a valve seat, the wall defining at least one upper spray hole positioned so as to provide a flow path through the wall, the at least one upper spray hole having a hole entry positioned on the internal surface and having a hole exit positioned on the external surface, and
an outer valve needle slideably positioned within the nozzle bore,
wherein the outer valve needle is engageable fluidtightly with the valve seat in order to control fuel delivery through the at least one upper spray hole,
wherein the outer valve needle is provided with a needle bore, within which an inner valve needle is slideably positioned and
wherein the tip of the inner valve needle is engageable fluidtightly with the valve seat in order to control fuel delivery through at least one axial spray hole aligned substantially parallel to the longitudinal axis of the injector nozzle
wherein, in use, when the inner valve needle is lifted away from the valve seat and held in an uppermost raised position, the minimum flow area, through which fuel to be injected through the axial spray hole must pass, is positioned between the inner valve needle and the nozzle body.

2. A fuel injector as claimed in claim 1, wherein, in use, when the outer valve needle is lifted away from its valve seat and held in an uppermost raised position, the minimum flow area of the at least one upper spray hole causes the greatest restriction of the flow rate of fuel through the at least one upper spray hole, and, when the inner valve needle is lifted away from its valve seat and held in an uppermost raised position, the minimum flow area between the tip of the inner valve needle and the valve seat causes the greatest restriction of the flow rate of fuel through the at least one axial spray hole.

3. A fuel injector as claimed in claim 1, wherein the valve seat is frustoconical, and the tip is conical, and wherein when, in use, the tip is raised away from the valve seat, the minimum flow area between the tip and its valve seat is formed as a conical annular region.

4. A fuel injector as claimed in claim 1, wherein the inner valve needle is provided with at least one groove parallel to its external surface and arranged diagonally relative to the longitudinal axis of the inner valve needle.

5. A fuel injector as claimed in claim 1, wherein the outer valve needle is provided with a first radial drilling and a second radial drilling that pass through the wall of the outer valve needle from an external surface to an internal surface of the bore, wherein the first radial drilling is offset to one side of the longitudinal axis of the outer valve needle and the second radial drilling is offset to the other side of the longitudinal axis of the outer valve needle.

6. A fuel injector as claimed in claim 1 wherein the outer valve needle is provided with a first radial drilling and a second radial drilling that pass through the wall of the outer valve needle from an external surface to an internal surface of the bore, wherein the longitudinal axes of the first and second radial drillings are aligned and intersect the longitudinal axis of the outer valve needle.

7. A fuel injector as claimed in any preceding claim wherein when, in use, the inner valve needle is seated against the valve seat the lowest point of the tip is positioned within the axial spray hole.

8. A fuel injector as claimed in any preceding claim wherein when, in use, the inner valve needle is raised away from the valve seat to its uppermost position the lowest point of the tip is positioned within the axial spray hole.

9. A fuel injector as claimed in claim 1, further comprising an insert, wherein a lower part of the insert is sealingly engaged with an internal surface of the bore of the nozzle body, an upper part of the insert is sealingly engageable with the tip of the inner valve needle and an outer part of the insert is sealingly engageable with the bore of the outer valve needle.

10. A fuel injector as claimed in any preceding claim wherein the tip further comprises a cylindrical lower section.

11. A fuel injector as claimed in claim 9 wherein the lower section is provided with a flat section.

12. A fuel injector as claimed in claim 1, wherein the tip further comprises is provided with a frustoconical upper section, an intermediate section that is circular in cross-section and that has a concave curved profile and a cylindrical lower section.
